(19) United States
(12) Patent Application Publication
(10) Pub. No.: US 2026/0370303 A1
(43) Pub. Date: Nov. 19, 2026

(54) METHOD AND SYSTEM FOR ALIGNING WIRELESS TRANSMISSION SIGNAL BEAM USING POINTING BEAM SIZE CONTROL

(71) Applicant: ELECTRONICS AND TELECOMMUNICATIONS RESEARCH INSTITUTE, Daejeon (KR)

(72) Inventors: Won Kyoung LEE, Daejeon (KR); Minkyu SUNG, Seoul (KR); Jun Ki LEE, Sejong-si (KR); Seung-Hyun CHO, Sejong-si (KR)

(73) Assignee: ELECTRONICS AND TELECOMMUNICATIONS RESEARCH INSTITUTE, Daejeon (KR)

(21) Appl. No.: 19/671,484

(22) Filed: May 8, 2026

(30) Foreign Application Priority Data
May 16, 2025 (KR) 10-2025-0064167

(51) Int. Cl. H04B 7/06; H01Q 25/00; H04B 1/40

(52) U.S. Cl. CPC H04B 7/06958; H01Q 25/002; H04B 1/40

(57) ABSTRACT

The method includes initially setting an antenna of a transmission unit and an antenna of a reception unit according to position information, transmitting a pointing acquisition tracking (PAT) beam having a beam size greater than or equal to a reference value from a PAT transceiver of the transmission unit, initially controlling the antenna of the reception unit to place a position of the PAT beam that a PAT transceiver of the reception unit receives, within a field of view plane, reducing the beam size of the PAT beam to less than the reference value, transmitting a PAT beam having a reduced beam size from the PAT transceiver of the transmission unit, receiving the PAT beam having the reduced beam size from the PAT transceiver of the reception unit, fine-controlling the antenna of the reception unit to place a position of the PAT beam having the reduced beam size at a center of the field of view plane, and when the position of the PAT beam having the reduced beam size is placed at the center of the field of view plane, transmitting data using a wireless transmission signal beam including data.

### CROSS-REFERENCE TO RELATED APPLICATION

This application claims the benefit of Korean Patent Application No. 10-2025-0064167, filed on May 16, 2025, in the Korean Intellectual Property Office (now the Ministry of Intellectual Property (MOIP)), the entire disclosure of which is incorporated herein by reference for all purposes.

### BACKGROUND

### 1. Field of the Invention

The present disclosure relates to a method and system for aligning and tracking a beam of a wireless transmission signal to improve long-distance transmission performance of high-frequency wireless communication with high directivity.

### 2. Description of the Related Art

With the rapidly increasing demand for data transmission speed, high-frequency wireless communication including terahertz frequencies has emerged as a technology for effectively providing a wireless communication service to areas without communication service or with insufficient communication service.

However, a high-frequency signal causes a significant path loss over distance and also has a problem of significant degradation of a wireless link in a non-line-of-sight environment.

To resolve the path loss problem in the high-frequency wireless communication, a directivity antenna is used, but it is difficult to align abeam with high directivity. For example, a terahertz signal has high straightness and directivity due to a small beam size, and for this reason, the terahertz signal has an advantage of having a low risk of threatening data security, such as interference with other signals or radio jamming. However, due to the small beam size, accurately aligning the terahertz signal takes a long time, and it is significantly difficult to rapidly track and precisely align a wireless transmission signal beam in a rapidly changing propagation/transmission environment due to bad weather or a change in atmospheric conditions.

Accordingly, there is a demand for a method of performing rapid and precise beam alignment in a high-frequency wireless communication.

### SUMMARY

The present disclosure may provide a method and system for performing beam alignment using two or more lasers having different beam sizes by adjusting a bandwidth of a broadband light source with a variable filter and adjusting a grating cycle of a chirped fiber Bragg grating (FBG).

A method of aligning a wireless transmission signal beam according to an embodiment includes initially setting an antenna of a transmission unit and an antenna of a reception unit according to position information, transmitting a pointing acquisition tracking (PAT) beam having a beam size greater than or equal to a reference value from a PAT transceiver of the transmission unit, initially controlling the antenna of the reception unit to place a position of the PAT beam that a PAT transceiver of the reception unit receives, within a field of view plane, reducing the beam size of the PAT beam to less than the reference value, transmitting a PAT beam having a reduced beam size from the PAT transceiver of the transmission unit, receiving the PAT beam having the reduced beam size from the PAT transceiver of the reception unit, fine-controlling the antenna of the reception unit to place a position of the PAT beam having the reduced beam size at a center of the field of view plane, and when the position of the PAT beam having the reduced beam size is placed at the center of the field of view plane, transmitting data using a wireless transmission signal beam including data.

The method further includes, before performing the initial setting, transmitting a PAT beam having an arbitrary beam size to the PAT transceiver and a quad cell coupled to the antenna of the reception unit via a beam splitter and the antenna of the transmission unit, and aligning the antenna of the transmission unit or the antenna of the reception unit such that a position of the PAT beam having the arbitrary beam size that the quad cell coupled to the antenna of the reception unit receives corresponds to a position of the PAT beam having the arbitrary beam size that a beam splitter of the reception unit receives.

The method further includes measuring wireless transmission performance of data using the wireless transmission signal beam, when the wireless transmission performance is less than or equal to a performance threshold, determining whether a pointing error, which is a difference between the position of the PAT beam having the reduced beam size and a center of the field of view plane, is greater than or equal to a pointing error threshold, and when the pointing error is greater than or equal to the pointing error threshold, realigning the antenna of the transmission unit and the antenna of the reception unit.

The transmitting of the data includes transmitting the data using the wireless transmission signal beam until the wireless transmission performance is less than or equal to the performance threshold or the pointing error is greater than or equal to the pointing error threshold.

The realigning includes when the pointing error is greater than or equal to the pointing error threshold and is less than an alignment maximum error, realigning the antenna of the transmission unit and the antenna of the reception unit to place the position of the PAT beam having the reduced beam size at the center of the field of view plane, and when the pointing error is greater than or equal to the alignment maximum error, after realigning the antenna of the transmission unit and the antenna of the reception unit to place a position of the PAT beam having the beam size greater than or equal to the reference value within the field of view plane, realigning the antenna of the transmission unit and the antenna of the reception unit to place the position of the PAT beam having the reduced beam size at the center of the field of view plane.

A system, including a transmission unit and a reception unit, for aligning a wireless transmission signal beam according to an embodiment includes the transmission unit configured to initially set an antenna of the transmission unit according to position information, generate a PAT beam having a beam size greater than or equal to a reference value and transmit the PAT beam to the transmission unit, and when a position of the PAT beam that the reception unit receives is placed within a field of view plane, reduce a beam size of the PAT beam to less than the reference value and transmit the PAT beam having the reduced beam size to the reception unit, and the reception unit configured to initially set an antenna of the reception unit according to position information, initially set the antenna of the reception unit to place the position of the PAT beam that the reception unit receives within the field of view plane, fine-control the antenna of the transmission unit to place the PAT beam having the reduced beam size and received by the reception unit at a center of the field of view plane, and when the position of the PAT beam having the reduced beam size is placed at the center of the field of view plane, send a request to the transmission unit for transmitting data, wherein the transmission unit is further configured to transmit the data to the reception unit using a wireless transmission signal beam including the data.

The transmission unit includes a terahertz transceiver of the transmission unit configured to generate a wireless transmission signal beam including data by modulating a carrier signal, an antenna of the transmission unit configured to transmit the wireless transmission signal beam, a quad cell coupled to the antenna of the transmission unit and configured to determine whether a PAT beam is aligned in a direction in which the antenna of the transmission unit is oriented, and a PAT transceiver of the transmission unit configured to transmit the PAT beam and control the antenna of the transmission unit, wherein the reception unit includes an antenna of the reception unit configured to receive the wireless transmission signal beam, a quad cell coupled to the antenna of the reception unit and configured to receive a PAT beam transmitted from the PAT transceiver of the transmission unit and identify a position of a received PAT beam, a terahertz transceiver of the reception unit configured to reconstruct data from a wireless transmission signal beam that the antenna of the reception unit receives, and a PAT transceiver of the reception unit configured to control the antenna of the reception unit.

The PAT transceiver of the transmission unit is further configured to, before performing the initial setting, transmit a PAT beam having an arbitrary beam size to the quad cell of the reception unit and the PAT transceiver of the reception unit via an alignment channel and the antenna of the transmission unit, and the PAT transceiver of the reception unit is further configured to align the antenna of the reception unit such that a position of the PAT beam that has the arbitrary beam size and is received by the quad cell of the reception unit corresponds to a position of the PAT beam that has the arbitrary beam size and is received via the alignment channel.

The PAT transceiver of the reception unit is further configured to measure wireless transmission performance of data using the wireless transmission signal beam, when the wireless transmission performance is less than or equal to a performance threshold, determine whether a pointing error, which is a difference between the position of the PAT beam having the reduced beam size and a center of the field of view plane, is greater than or equal to a pointing error threshold, and when the pointing error is greater than or equal to the pointing error threshold, realign the antenna of the reception unit.

The PAT transceiver of the reception unit is further configured to, when the pointing error is greater than or equal to the pointing error threshold and is less than an alignment maximum error, realign the antenna of the reception unit to place the position of the PAT beam having the reduced beam size at the center of the field of view plane, and when the pointing error is greater than or equal to the alignment maximum error, after realigning the antenna of the reception unit to place a position of the PAT beam having the beam size greater than or equal to the reference value within the field of view plane, realign the antenna of the reception unit to place the position of the PAT beam having the reduced beam size at the center of the field of view plane.

The PAT transceiver of the transmission unit includes an antenna controller configured to control the antenna of the transmission unit, a variable beam generator configured to generate PAT beams having different beam sizes, a collimator configured to correct the PAT beam to be parallel, and a beam splitter configured to split the PAT beam and transmit a portion of the PAT beam to the antenna of the transmission unit and the other portion of the PAT beam to the PAT transceiver of the reception unit.

The variable beam generator includes an amplified spontaneous emission (ASE) light source, a first chirped FBG including a grating structure in which a long wavelength is reflected first, a second chirped FBG including a grating structure in which a short wavelength is reflected first, a first switch configured to transmit a beam output from the ASE light source to one of an optical coupler and a second switch, the second switch configured to transmit a beam received from the first switch to the first chirped FBG and the second chirped FBG, the optical coupler configured to transmit light received from one of the first switch, the first chirped FBG, and the second chirped FBG to an optical amplifier, and the optical amplifier configured to amplify and output received light.

The variable beam generator is further configured to, when the first switch transmits the beam output from the ASE light source to the optical coupler, output a PAT beam having a beam size corresponding to a beam size of the ASE light source.

The variable beam generator is further configured to, when the second switch transmits the beam output from the ASE light source to the first chirped FBG, increase a beam size of the beam received by the first chirped FBG to the reference value or above and output the PAT beam having the beam size greater than or equal to the reference value.

The variable beam generator is further configured to, when the second switch transmits the beam output from the ASE light source to the second chirped FBG, reduce a beam size of the beam received by the second chirped FBG to less than the reference value and output the PAT beam having the reduced beam size.

The variable beam generator further includes a variable filter configured to select a bandwidth of the beam output from the ASE light source, and the variable filter is further configured to, when the second switch transmits the beam output from the ASE light source to the first chirped FBG, select the bandwidth of the beam output from the ASE light source to gradually increase a time difference between a short wavelength and a long wavelength of the beam output from the ASE light source.

The variable beam generator further includes a variable filter configured to select a bandwidth of the beam output from the ASE light source, and the variable filter is further configured to, when the switch transmits the beam output from the ASE light source to the second chirped FBG, select the bandwidth of the beam output from the ASE light source to gradually decrease a time difference between a short wavelength and a long wavelength of the beam output from the ASE light source.

The PAT transceiver of the reception unit includes an antenna controller configured to control the antenna of the reception unit, a beam splitter configured to receive, from the PAT transceiver of the reception unit, a PAT beam generated by the PAT transceiver of the reception unit and transmit the PAT beam to a camera focal plane array (FPA), and the camera FPA configured to identify a position of the received PAT beam.

The terahertz transceiver of the transmission unit includes a first light source configured to output a carrier beam, a modulator configured to modulate the carrier beam into a data pattern and output a data signal beam, a second light source configured to output a local signal beam used for beating, a nonlinear element configured to generate a wireless transmission signal beam by combining the data signal beam with the local signal beam, and an amplifier configured to amplify and transmit the wireless transmission signal beam to the antenna of the transmission unit.

The terahertz transceiver of the reception unit includes a mixer configured to perform frequency down conversion on a wireless transmission signal beam that the antenna of the reception unit receives from the antenna of the transmission unit, and a signal processor configured to reconstruct data transmitted from the terahertz transceiver of the transmission unit from a beam output from the mixer.

Additional aspects of embodiments will be set forth in part in the description which follows and, in part, will be apparent from the description, or may be learned by practice of the disclosure.

According to an embodiment, limitations of a conventional PAT technology, such as inefficient cost, low precision alignment performance, and long alignment time, may be overcome by performing beam alignment using two or more lasers having different beam sizes.

According to an embodiment, a PAT beam size may gradually increase or decrease by adjusting a bandwidth of a broadband light source with a variable filter and adjusting a grating cycle of a chirped FBG.

According to an embodiment, beam tracking and alignment time may be minimized and a wireless transmission signal beam with high directivity may be precisely aligned by aligning with an optimized beam size according to a transmission environment or a carrier signal rather than a fixed beam size.

Accordingly, according to an embodiment, long-distance high-speed data transmission performance may be improved by rapidly tracking and precisely aligning a high-frequency beam with high directivity.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a wireless transmission signal beam alignment system according to an embodiment;

FIG. 2 is an example of an initial setting process of an antenna of a wireless transmission signal beam alignment system according to an embodiment;

FIG. 3 is an example of a control process of an antenna of a wireless transmission signal beam alignment system according to an embodiment;

FIG. 4 is an example of a precise control process of an antenna of a wireless transmission signal beam alignment system according to an embodiment;

FIG. 5 is an example of an antenna tracking control process during data transmission of a wireless transmission signal beam alignment system according to an embodiment.

FIG. 6 is an example of a detailed structure of a terahertz (THz) transceiver of a wireless transmission signal beam alignment system according to an embodiment;

FIG. 7 is another example of a detailed structure of a THz transceiver of a multi-channel wireless transmission system according to an embodiment;

FIG. 8 is an example of a detailed structure of a three-beam generator of a wireless transmission signal beam alignment system according to an embodiment;

FIG. 9 is another example of a detailed structure of a variable beam generator of a wireless transmission signal beam alignment system according to an embodiment;

FIG. 10 is a diagram illustrating a principle of reducing the size of a pointing acquisition tracking (PAT) beam by a variable beam generator of a wireless transmission signal beam alignment system according to an embodiment;

FIG. 11 is a diagram illustrating a principle of increasing the size of a PAT beam by a variable beam generator of a wireless transmission signal beam alignment system according to an embodiment;

FIG. 12 is a flowchart illustrating a wireless transmission signal beam alignment method according to an embodiment; and

FIG. 13 is a flowchart illustrating a tracking process of a wireless transmission signal beam alignment method according to an embodiment.

### DETAILED DESCRIPTION

Hereinafter, embodiments will be described in detail with reference to the accompanying drawings. A wireless transmission signal beam alignment method according to an embodiment may be performed by a wireless transmission signal beam alignment system.

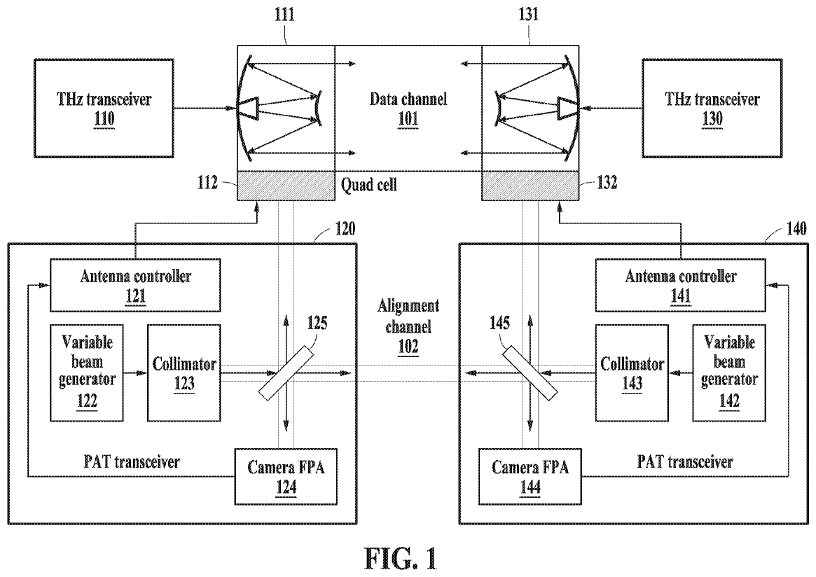

FIG. 1 is a diagram illustrating a wireless transmission signal beam alignment system according to an embodiment.

A wireless transmission signal beam alignment system may include a transmission unit including a terahertz (THz) transceiver 110, an antenna 111, and a pointing acquisition tracking (PAT) transceiver 120, and a reception unit including a THz transceiver 130, an antenna 131, and a PAT transceiver 140, as shown in FIG. 1. In this case, the transmission unit and the reception unit may be classified according to operations of transmitting data and receiving data by a wireless transmission signal beam alignment control device including a THz transceiver (110, 130), an antenna (111, 131), and a PAT transceiver (120, 140). Accordingly, when one wireless transmission signal beam alignment control device transmits data, the wireless transmission signal beam alignment control device may operate as the transmission unit, and when the wireless transmission signal beam alignment control device receives data from another wireless transmission signal beam alignment control device, the wireless transmission signal beam alignment control device may operate as the reception unit.

In other words, the THz transceiver 110, the antenna 111, and the PAT transceiver 120 may each include a function for performing operations of the THz transceiver 130, the antenna 131, and the PAT transceiver 140, and the THz transceiver 130, the antenna 131, and the PAT transceiver 140 may each also include a function for performing operations of the THz transceiver 110, the antenna 111, and the PAT transceiver 120.

In addition, depending on the embodiment, the wireless transmission signal beam alignment control device may include a transmitter, which is hardware including only a function of the transmission unit, and a receiver, which is hardware including only a function of the reception unit.

The THz transceiver 110 may generate a wireless transmission signal beam including data by modulating a carrier signal.

After the alignment of the wireless transmission signal beam is completed by the PAT transceiver 120, the antenna 111 may transmit the wireless transmission signal beam generated by the THz transceiver 110 to the reception unit via a data channel 101.

A quad cell 112 may include four receivers (photodiodes) that receive a PAT beam and may be coupled to the antenna 111 to receive a PAT beam from the PAT transceiver (120) in a direction pointed by the antenna 111. In other words, since the direction and angle of the quad cell 112 are the same as those of the antenna 111, the direction and angle of the antenna 111 may be aligned using the PAT beam transmitted from the PAT transceiver (120) and received on the quad cell 112. In addition, the quad cell 112 may check whether the transmitted PAT beam is aligned in the direction pointed by the antenna 111.

In addition, the quad cell 112 may receive a PAT beam from a quad cell 120. In this case, the quad cell 112 may identify a position in which the PAT beam is received according to intensities of PAT beams that the four receivers receive. For example, when the intensities of the PAT beams that the four receivers receive are different, the quad cell 112 may determine a position of the receiver with the highest intensity of the received PAT beam to be the position in which the PAT beam is received. In addition, when one of the receivers receives the PAT beam, the quad cell 112 may identify the position in which the PAT beam is received according to the position of the receiver that receives the PAT beam.

The PAT transceiver 120 may align wireless transmission signal beams of the transmission unit and the reception unit with one another by controlling the antenna 111 using information related to alignment, such as field of view and received signal intensity. As shown in FIG. 1, the PAT transceiver 120 may include an antenna controller 121, a variable beam generator 122, a collimator 123, a camera focal plane array (FPA) 124, and a beam splitter 125.

The antenna controller 121 may control the direction and angle of the antenna 111 by transmitting a control signal to a control device of the antenna 111.

The variable beam generator 122 may generate and output a PAT beam. In this case, the variable beam generator 122 may generate and output a PAT beam having an arbitrary beam size. In addition, the variable beam generator 122 may increase the beam size of the output PAT beam to a reference value or above or may decrease the beam size thereof to less than the reference value.

The collimator 123 may convert the divergent PAT beam output from the variable beam generator 122 into a parallel beam.

The beam splitter 125 may split the parallel PAT beam converted by the collimator 123 and may transmit a portion of the PAT beam to the quad cell 112. In addition, the beam splitter 125 may transmit the remainder of the PAT beam to the PAT transceiver 140 of the reception unit via an alignment channel 102. In addition, the beam splitter 125 may receive the PAT beam generated by the PAT transceiver 140 from the PAT transceiver 140 of the reception unit and may transmit the received PAT beam to the camera FPA 124.

The camera FPA 124 may identify a position of the PAT beam received from the beam splitter 125.

The antenna 131 may transmit or receive a wireless transmission signal beam via the data channel 101.

The THz transceiver 130 may reconstruct data from the wireless transmission signal beam that the antenna 131 receives.

The quad cell 132 may include four receivers and may be coupled to the antenna 131 to receive a PAT beam in a direction pointed by the antenna 131. In other words, since the direction and angle of the quad cell 132 are the same as those of the antenna 131, the direction and angle of the antenna 131 may be aligned using a PAT beam that the quad cell 132 receives. The PAT beam that the quad cell 132 receives may be a PAT beam transmitted from the PAT transceiver 120 of the transmission unit using the quad cell 112.

The PAT transceiver 140 may control the antenna 131. An antenna controller 141, a variable beam generator 142, a collimator 143, a camera FPA 144, and a beam splitter 145 included in the PAT transceiver 140 may perform operations of the antenna controller 121, the variable beam generator 122, the collimator 123, the camera FPA 124, and the beam splitter 125, respectively.

Hereinafter, operations of the wireless transmission signal beam alignment system are described.

The PAT transceiver 120 may control the antenna 111 such that a PAT beam and a wireless transmission signal beam are aligned in parallel using the quad cell 112 and the camera FPA 124.

In this case, the PAT transceiver 120 may transmit a PAT beam having an arbitrary beam size to the PAT transceiver 140 of the reception unit via the beam splitter 125. In this case, the arbitrary beam size may be a randomly determined beam size or a beam size that is preset to the PAT transceiver 120.

Specifically, the PAT transceiver 120 may split a PAT beam having an arbitrary beam size and may transmit a portion thereof to the quad cell 112 and the remainder to the alignment channel 102.

In this case, the beam splitter 145 of the PAT transceiver 140 may transmit the received PAT beam having the arbitrary beam size to the camera FPA 144. In addition, the camera FPA 144 may identify a position of the PAT beam having the arbitrary beam size that the beam splitter 145 receives from the beam splitter 125 via the alignment channel 102.

In this case, the antenna controller 141 of the PAT transceiver 140 may align the antenna 131 such that the antenna controller 141 may cause the PAT beam having the arbitrary beam size to be parallel with the wireless transmission signal beam by controlling the antenna 131 to ensure the position of the PAT beam having the arbitrary beam size that the quad cell 132 receives to coincide with the position of the PAT beam having the arbitrary beam size that the camera FPA 144 receives. In addition, when the position of the PAT beam having the arbitrary beam size is at the center of the camera FPA 144, the antenna controller 141 may control the antenna 131 to maximize the intensity of the wireless transmission signal beam that the antenna 131 receives, thereby causing the PAT beam having the arbitrary beam size to be parallel with the wireless transmission signal beam.

The PAT transceiver 120 may initially set the antenna 111 according to position information of the reception unit, obtained using a global positioning system (GPS), and the PAT transceiver 140 may initially set the antenna 131 according to position information of the transmission unit, obtained using the GPS.

The PAT transceiver 120 may transmit a PAT beam having a beam size greater than or equal to a reference value to the quad cell 112 and the PAT transceiver 140. When a beam size of the PAT beam having an arbitrary beam size is greater than or equal to the reference value, the PAT transceiver 120 may transmit the PAT beam to the quad cell 112 and the PAT transceiver 140. When the beam size of the PAT beam having the arbitrary beam size is less than the reference value, the PAT transceiver 120 may increase the beam size of the PAT beam to the reference value or above. In addition, the PAT transceiver 120 may transmit the PAT beam having the increased beam size greater than or equal to the reference value to the quad cell 112 and the PAT transceiver 140.

The beam splitter 145 of the PAT transceiver 140 may transmit the PAT beam having the beam size greater than or equal to the reference value to the camera FPA 144 via the alignment channel 102, wherein the PAT beam is incident on the beam splitter 145. In addition, the PAT transceiver 140 may perform coarse alignment for controlling the antenna 131 such that the position of the PAT beam that the camera FPA 144 receives is placed within a field of view plane.

Thereafter, the PAT transceiver 120 may reduce the beam size of the PAT beam to less than the reference value. In addition, the PAT transceiver 120 may transmit the PAT beam having the reduced beam size to the quad cell 112 and the PAT transceiver 140. For example, the PAT transceiver 120 may repeat a process of sequentially generating and transmitting PAT beams having reduced beam sizes, wherein the beam sizes gradually decrease.

The beam splitter 145 of the PAT transceiver 140 may transmit the PAT beam incident on the beam splitter 145 to the camera FPA 144 via the alignment channel 102. In this case, the PAT beam incident on the beam splitter 145 via the alignment channel 102 may be a PAT beam having the beam size reduced to less than the reference value.

In addition, the PAT transceiver 140 may perform gradually fine alignment for fine-controlling the antenna 131 such that the position of the PAT beam that the camera FPA 144 receives is placed at the center of the field of view plane.

When the position of the PAT beam having the reduced beam size is placed at the center of the field of view plane by fine-controlling the antenna 131, the PAT transceiver 140 may drive the THz transceiver 130 and may send a request to the THz transceiver 110 for data transmission.

The antenna 111 may transmit the wireless transmission signal beam generated by the THz transceiver 110 to the reception unit via the data channel 101. In this case, the THz transceiver 130 may reconstruct data from the wireless transmission signal beam that the antenna 131 receives.

While the data is transmitted from the THz transceiver 110 to the THz transceiver 130, the PAT transceiver 140 may measure wireless transmission performance of data using the wireless transmission signal beam. For example, the wireless transmission performance may include at least one of a bit error rate (BER), an eye height, and a signal-to-noise ratio (SNR).

In addition, the PAT transceiver 140 may determine whether the wireless transmission performance is less than or equal to a performance threshold. When the wireless transmission performance is less than or equal to the performance threshold, the PAT transceiver 140 may determine whether a pointing error, which is the difference between the position of the PAT beam having the reduced beam size and the center of the field of view plane, is greater than or equal to a pointing error threshold. When the wireless transmission performance exceeds the performance threshold or the pointing error is less than the pointing error threshold, the PAT transceiver 140 may maintain the control state of the antenna 131 without changing.

When the pointing error is greater than or equal to the pointing error threshold, the PAT transceiver 140 may realign the antenna 131.

When the pointing error is greater than or equal to the pointing error threshold and less than an alignment maximum error, the PAT transceiver 140 may perform gradually fine alignment for realigning the antenna 131 such that the position of the PAT beam having the reduced beam size is placed at the center of the field of view plane.

When the pointing error is greater than or equal to the alignment maximum error, the PAT transceiver 140 may perform coarse alignment for realigning the antenna 131 such that the position of the PAT beam having the beam size greater than or equal to the reference value is placed within the field of view plane. After performing the coarse alignment, the PAT transceiver 140 may perform gradually fine alignment for realigning the antenna 131 such that the position of the PAT beam having the reduced beam size is placed at the center of the field of view plane.

The wireless transmission signal beam alignment system of the present disclosure may overcome limitations of a conventional PAT technology, such as inefficient cost, low-precision alignment performance, and long alignment time, by aligning a beam using two or more lasers having different beam sizes.

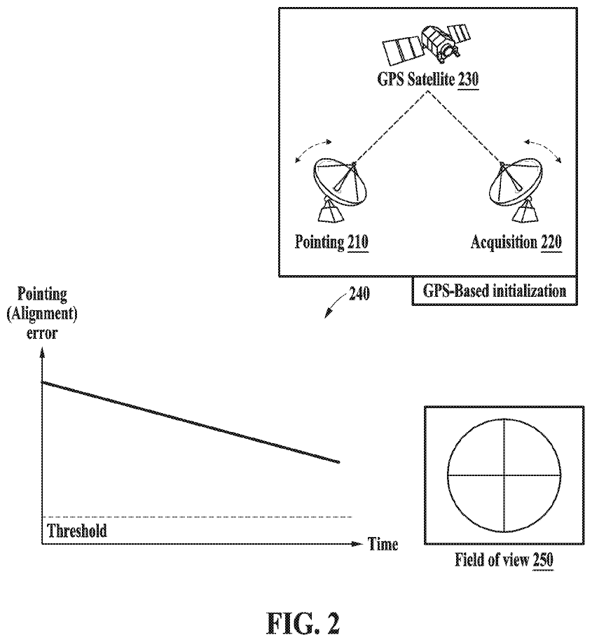

FIG. 2 is an example of an initial setting process of an antenna of a wireless transmission signal beam alignment system according to an embodiment.

As shown in FIG. 2, the wireless transmission signal beam alignment system may include a wireless transmission signal beam alignment device operating as a transmission unit 210, a wireless transmission signal beam alignment device operating as a reception unit 220, and A GPS sensor that receives positioning data of the transmission unit 210 and reception unit 220 from satellites 230 (GPS satellites). “Pointing” in FIG. 2 may refer to an operation of transmitting a PAT beam from the transmission unit 210 by controlling antenna alignment of the transmission unit 210 according to a position information of an antenna of the reception unit 220 received from the GPS satellite. In addition, “Acquisition” in FIG. 2 may refer to an operation in which the reception unit 220 obtains the PAT beam transmitted from the transmission unit 210 by controlling antenna alignment of the reception unit 220.

In this case, the transmission unit 210 may initially set the antenna 111 according to the position information of the reception unit 220, obtained using the GPS of the satellite 230, and the reception unit 220 may initially set the antenna 131 according to the position information of the transmission unit 210, obtained using the GPS of the satellite 230.

In addition, since the system is in its initial stage of antenna alignment for both the transmission and reception units using only GPS information, a pointing error measured in the reception unit 220 may be far beyond the threshold shown as a graph 240, the PAT beam position may be not detected within a field of view plane 250 of the reception unit 220 shown in FIG. 2.

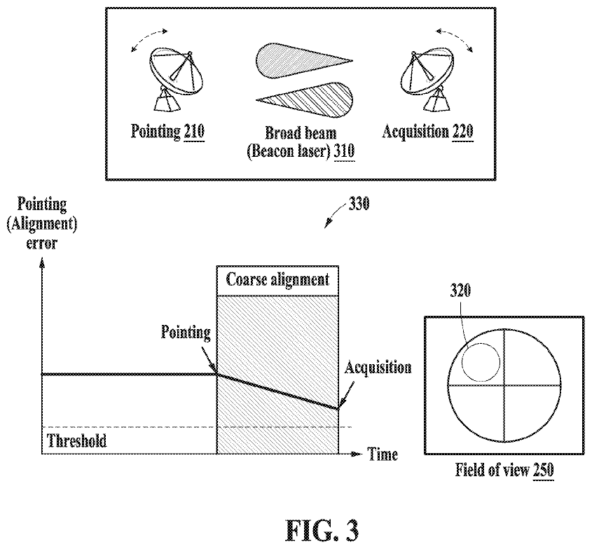

FIG. 3 is an example of a control process of an antenna of a wireless transmission signal beam alignment system according to an embodiment.

The transmission unit 210 may output a PAT beam 310 having a beam size greater than or equal to a reference value toward the reception unit 220. In this case, the PAT beam 310 having the beam size greater than or equal to the reference value may be a broad beam having a beam size greater than or equal to the reference value. For example, the PAT beam 310 having the beam size greater than or equal to the reference value may be a beacon laser having a wide beam size with a beam divergence angle of several milliradians (mrad).

In addition, the reception unit 220 may control the antenna 131 of the reception unit 220 such that a position 320 of the received PAT beam 310 having the beam size greater than or equal to the reference value is placed within the field of view plane 250, as shown in FIG. 3. In this case, the reception unit 220 may perform coarse alignment on the antenna 131.

In this case, a pointing error measured in the reception unit 220 may be reduced in a section in which the coarse alignment is performed on the antenna 131, as shown in a graph 330 of FIG. 3.

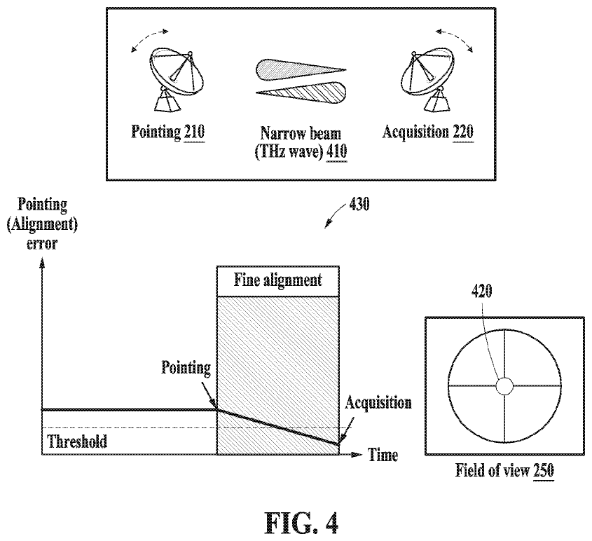

FIG. 4 is an example of a precise control process of an antenna of a wireless transmission signal beam alignment system according to an embodiment.

The transmission unit 210 may output a PAT beam 410 having a reduced beam size toward the reception unit 220. In this case, the PAT beam 410 having the reduced beam size may be a narrow beam having a beam size less than a reference value. For example, the PAT beam 410 having the reduced beam size may be a THz wave having a wide beam size with a beam divergence angle of several microradians (rad).

In addition, the reception unit 220 may fine-control the antenna 131 of the reception unit 220 such that a position 420 of the received PAT beam 410 having the reduced beam size is placed at the center of the field of view plane 250, as shown in FIG. 4. In this case, the reception unit 220 may perform fine alignment on the antenna 131.

In this case, a pointing error measured in the reception unit 220 may be reduced less than or equal to a threshold in a section in which the fine alignment is performed on the antenna 131, as shown in the graph 430 of FIG. 4.

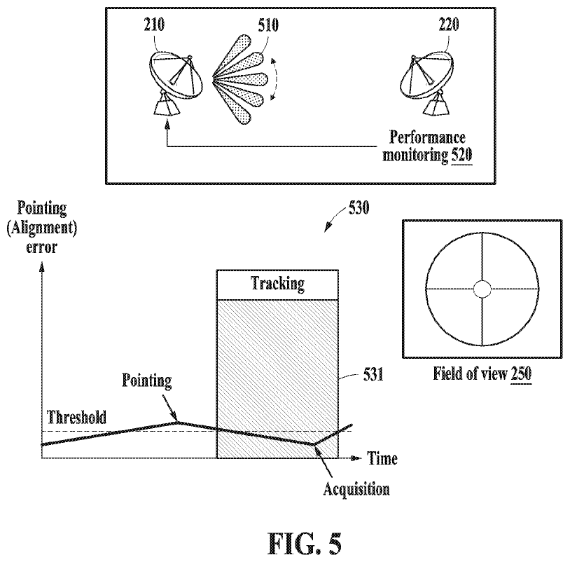

FIG. 5 is an example of an antenna control process during data transmission of a wireless transmission signal beam alignment system according to an embodiment.

After fine alignment is completed, the transmission unit 210 may transmit data using a wireless transmission signal beam 510. As time elapses, the characteristics of a wireless communication channel may change, and the performance of the reception unit 220 may be degraded. Accordingly, the reception unit 220 may monitor wireless transmission performance of data using a wireless transmission signal beam. Specifically, the reception unit 220 may monitor whether a pointing error exceeds a threshold.

As shown in a graph 530 of FIG. 5, when the pointing error exceeds the threshold, the reception unit 220 may realign the antenna 131 of the reception unit 220 by tracking 531 an angle of the antenna 131 of the reception unit 220 to optimize the position of the wireless transmission signal beam using the PAT beam. In this case, when the pointing error is greater than or equal to the pointing error threshold and less than an alignment maximum error, the PAT transceiver 140 may perform gradually fine alignment for realigning the antenna 131 such that the position of the PAT beam having the reduced beam size is placed at the center of the field of view plane.

When the pointing error is greater than or equal to the alignment maximum error, the PAT transceiver 140 may perform coarse alignment for realigning the antenna 131 such that the position of the PAT beam having the beam size greater than or equal to the reference value is placed within the field of view plane. After performing the coarse alignment, the PAT transceiver 140 may perform gradually fine alignment for realigning the antenna 131 such that the position of the PAT beam having the reduced beam size is placed at the center of the field of view plane.

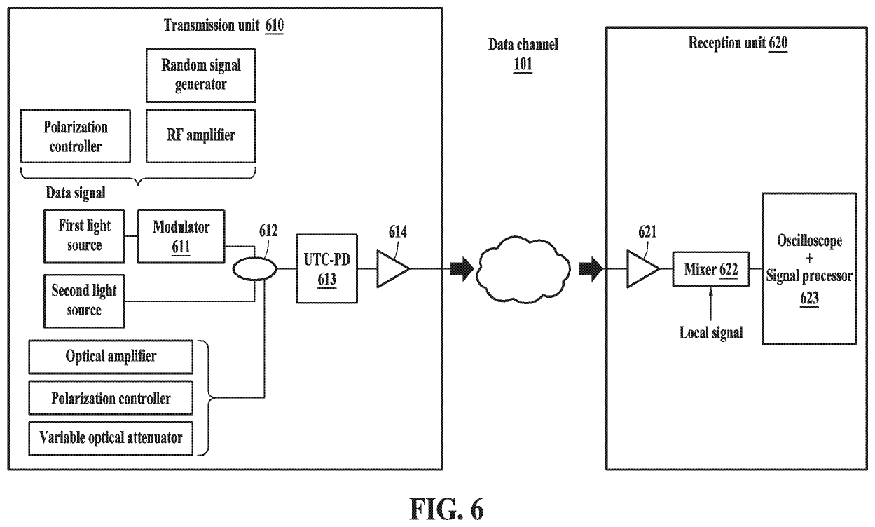

FIG. 6 is an example of a detailed structure of a THz transceiver of a wireless transmission signal beam alignment system according to an embodiment.

The THz transceiver of a transmission unit 610 may include a first light source, a modulator 611, a coupler 612, a nonlinear element 613, and an amplifier 614.

The first light source may output a carrier beam, and a second light source may output a local signal beam used for beating.

The modulator 611 may output a data signal beam by modulating the carrier beam into a data pattern. For example, the modulator 611 may include a polarization controller, a radio frequency (RF) amplifier, and a random signal generator.

The coupler 612 may combine and transmit the data signal beam with the local signal beam to the nonlinear element 613. In this case, the coupler 612 may adjust the beam in which the data signal beam is combined with the local signal beam using one of an optical amplifier, the polarization controller, and a variable optical attenuator.

The nonlinear element 613 may generate a wireless transmission signal beam using the beam in which the data signal beam is combined with the local signal beam. For example, the nonlinear element 613 may be a uni-travelling-carrier photodiode (UTC-PD).

The amplifier 614 may amplify and transmit the wireless transmission signal beam generated by the nonlinear element 613 to an antenna of the transmission unit 610. The wireless transmission signal beam output from the antenna of the transmission unit 610 may be transmitted to an antenna of a reception unit 620 via the data channel 101.

A THz transceiver of the reception unit 620 may include an amplifier 621, a mixer 622, and a signal processor 623.

The amplifier 621 may amplify and transmit a wireless transmission signal beam that the antenna of the reception unit 620 receives from the antenna of the transmission unit 610, to the mixer 622.

The mixer 622 may perform frequency down conversion on the wireless transmission signal beam received from the amplifier 621 and may output the result. In this case, the mixer 622 may perform frequency down conversion thereon according to a local signal.

The signal processor 623 may reconstruct data that is transmitted from the THz transceiver of the transmission unit 610, from the beam output from the mixer 622. In this case, the signal processor 623 may include an oscilloscope, as shown in FIG. 6, or a structure combined with an oscilloscope.

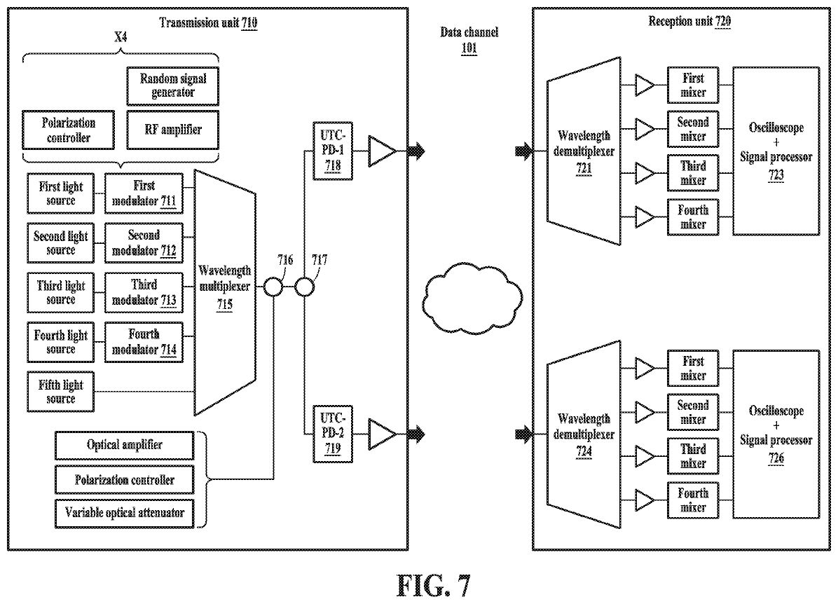

FIG. 7 is a detailed structure of a THz transceiver of a wireless transmission signal beam alignment system for reconstructing data after transmitting a wireless transmission signal beam of a multi-channel.

A THz transceiver of a transmission unit 710 may include a first light source, a second light source, a third light source, a fourth light source, a fifth light source, a first modulator 711, a second modulator 712, a third modulator 713, a fourth modulator 714, a wavelength multiplexer 715, a coupler 716, a first nonlinear element 718 and a second nonlinear element 719.

The first, second, third, and fourth light sources may output carrier beams of different channels, and the fifth light source may output a local signal beam used for beating.

The first modulator 711, the second modulator 712, the third modulator 713, and the fourth modulator 714 may output data signal beams by modulating carrier beams that the first, second, third, and fourth light sources respectively receive into different data patterns. For example, the first modulator 711, the second modulator 712, the third modulator 713, and the fourth modulator 714 may each include a polarization controller, an RF amplifier, and a random signal generator.

The wavelength multiplexer 715 may combine data signal beams respectively output from the first modulator 711, the second modulator 712, the third modulator 713, and the fourth modulator 714 with the local signal beam output from the fifth light source into one beam using different wavelengths.

The coupler 716 may adjust the beam output from the wavelength multiplexer 715 using one of an optical amplifier, a polarization controller, and a variable optical attenuator.

A polarization splitter 717 may split the beam output from the coupler 716 into two and may transmit the split beams to the first nonlinear element 718 and the second nonlinear element 719, respectively. In addition, depending on the embodiment, the number of nonlinear elements may be two or more, and the polarization splitter 717 may split a beam output from the coupler 716 according to the number of nonlinear elements.

The first nonlinear element 718 and the second nonlinear element 719 may generate wireless transmission signal beams using the received beams, respectively. For example, the first nonlinear element 718 and the second nonlinear element 719 may be UTC-PDs.

The THz transceiver of the reception unit 720 may include a first wavelength demultiplexer 721, a first mixer, a second mixer, a third mixer, a fourth mixer, a first signal processor 723, a second wavelength demultiplexer 724, a first mixer, a second mixer, a third mixer, a fourth mixer, and a second signal processor 726.

The first wavelength demultiplexer 721 may output four beams by demultiplexing the wireless transmission signal beam generated by the first nonlinear element 718.

The first mixer, the second mixer, the third mixer, and the fourth mixer may perform frequency down conversion on the beams output from the first wavelength demultiplexer 721, respectively, and may output the results.

The first signal processor 723 may reconstruct a data pattern (data transmitted from the THz transceiver of the transmission unit 710) used by the first modulator 711, the second modulator 712, the third modulator 713, and the fourth modulator 714 of the transmission unit 710 from the beams output from the first mixer, the second mixer, the third mixer, and the fourth mixer, respectively.

The second wavelength demultiplexer 724 may output four beams by demultiplexing the wireless transmission signal beam generated by the second nonlinear element 719.

The first mixer, the second mixer, the third mixer, and the fourth mixer may perform frequency down conversion on the beams output from the second demultiplexer 724 and may output the results.

The second signal processor 726 may reconstruct a data pattern (data transmitted from the THz transceiver of the transmission unit 710) used by the first modulator 711, the second modulator 712, the third modulator 713, and the fourth modulator 714 of the transmission unit 710 from the beams output from the first mixer, the second mixer, the third mixer, and the fourth mixer, respectively. In this case, the first signal processor 723 and the second signal processor 726 may each include an oscilloscope, as shown in FIG. 7, or may each have a structure combined with an oscilloscope.

In addition, the number of demultiplexers and the number of signal processors included in the reception unit 720 may correspond to the number of nonlinear elements included in the transmission unit 710. Furthermore, the number of mixers included in the reception unit 720 may correspond to the number of modulators included in the transmission unit 710.

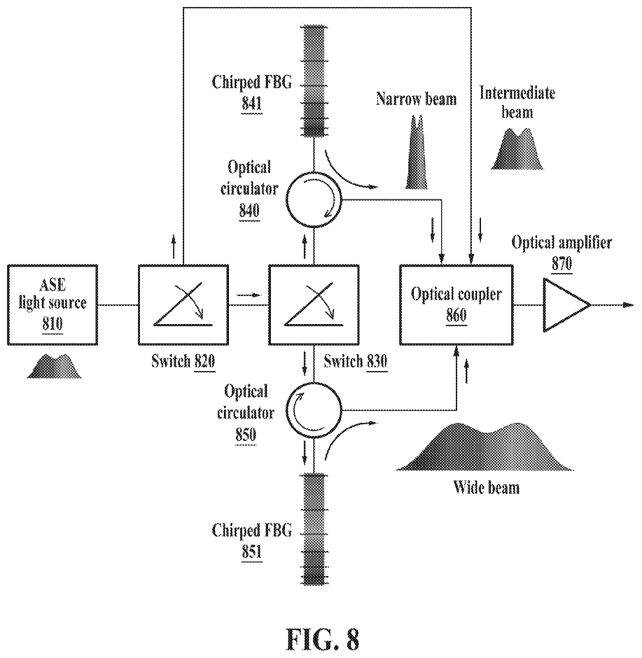

FIG. 8 is an example of a structure of a variable beam generator of a wireless transmission signal beam alignment system according to an embodiment.

A variable beam generator of a wireless transmission signal beam alignment system may include an amplified spontaneous emission (ASE) light source 810, a first switch 820, a second switch 830, a first optical circulator 840, a first chirped FBG 841, a second optical circulator 850, a second chirped FBG 851, an optical coupler 860, and an optical amplifier 870.

The first switch 820 may transmit a beam output from the ASE light source 810 to the optical coupler 860 or the second switch 830.

The second switch 830 may transmit the beam received from the first switch 820 to one of the first chirped FBG 841 and the second chirped FBG 851.

The first optical circulator 840 may transmit the beam output from the second switch 830 to the first chirped FBG 841 and may transmit a beam reflected from the first chirped FBG 841 to the optical coupler 860.

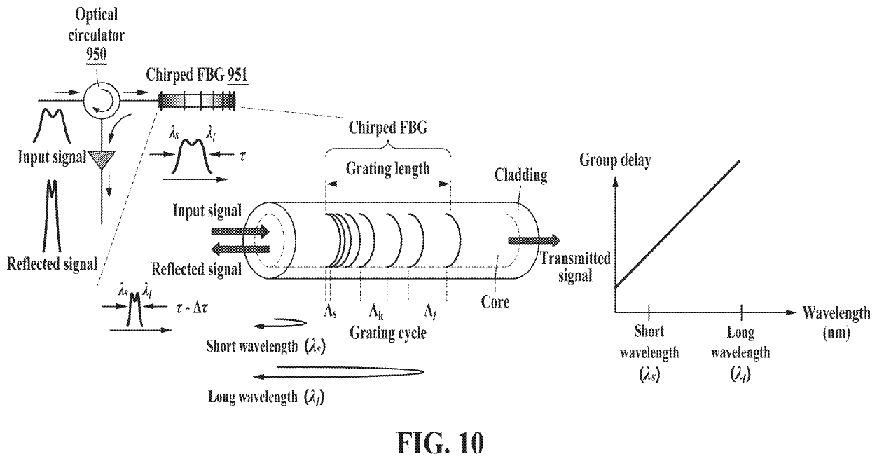

The first chirped FBG 841 may include a grating structure that reflects a long wavelength first. The beam reflected from the first chirped FBG 841 may have a reduced beam size compared to a beam incident on the first chirped FBG 841. The principle of reducing the beam size of an incident beam by the first chirped FBG 841 is further described with reference to FIG. 10.

The second optical circulator 850 may transmit the beam output from the second switch 830 to the second chirped FBG 851 and may transmit a beam reflected from the second chirped FBG 851 to the optical coupler 860.

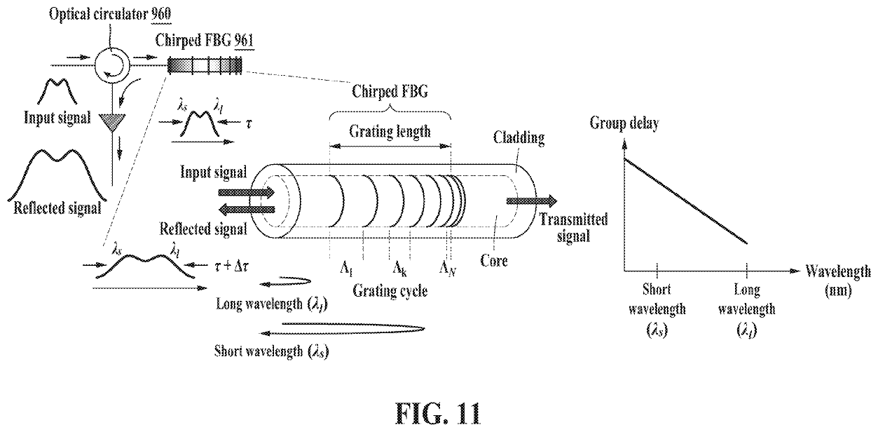

The second chirped FBG 851 may include a grating structure that reflects a short wavelength first. The beam reflected from the second chirped FBG 851 may have an increased beam size compared to a beam incident on the second chirped FBG 851. The principle of increasing the beam size of an incident beam by the second chirped FBG 851 is further described with reference to FIG. 11.

The optical coupler 860 may transmit light received from one of the first switch 820, the first chirped FBG 841, and the second chirped FBG 851 to the optical amplifier 870.

The optical amplifier 870 may amplify and output the received light.

The variable beam generator included in the PAT transceiver in the present disclosure may generate PAT beams having two or more beam sizes from one light source, thereby effectively aligning beams by adjusting a PAT beam size according to a beam size of a data carrier signal in a cost-effective manner.

A beam output from the ASE light source 810 may be a beam having an intermediate beam size.

Accordingly, when the first switch 820 transmits the beam output from the ASE light source 820 to the optical coupler 860, the beam may not pass through the first chirped FBG 841 or the second chirped FBG 851 and may be incident on the optical coupler 860, and the beam amplified and output by the optical amplifier 870 may be a beam having the intermediate beam size.

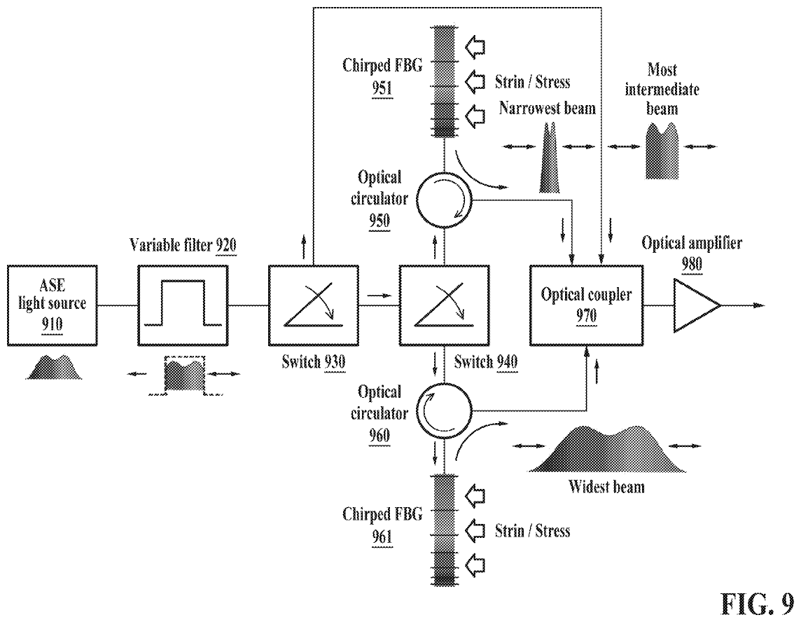

FIG. 9 is another example of a structure of a variable beam generator of a wireless transmission signal beam alignment system according to an embodiment.

A variable beam generator of a wireless transmission signal beam alignment system may include an ASE light source 910, a variable filter 920, a first switch 930, a second switch 940, a first optical circulator 950, a first chirped FBG 951, a second optical circulator 960, a second chirped FBG 961, an optical coupler 970, and an optical amplifier 980. Since the first switch 930, the second switch 940, the first optical circulator 950, the first chirped FBG 951, the second optical circulator 960, the second chirped FBG 961, the optical coupler 970, and the optical amplifier 980 respectively have the same configurations as the first switch 820, the second switch 830, the first optical circulator 840, the first chirped FBG 841, the second optical circulator 850, the second chirped FBG 851, the optical coupler 860, and the optical amplifier 870, detailed descriptions thereof are omitted.

The variable filter 920 may gradually change a PAT beam size from a wide beam size to a narrow beam size according to a frequency of a transmission carrier signal. Specifically, the variable filter 920 may change a bandwidth of light incident on the first switch 930 by selecting a specific bandwidth from a beam output from the ASE light source 910 and changing the selected bandwidth. In addition, the variable filter 920 may be replaced with a component for changing a bandwidth of light incident on the first switch 930 by changing the length of dispersed optical fiber.

When the beam of which the bandwidth is changed by the variable filter 920 is incident on the first chirped FBG 951 or the second chirped FBG 961, the size of the wide beam and the size of the narrow beam may be gradually changed by changing a reflected wavelength according to a grating cycle of the first chirped FBG 951 or the second chirped FBG 961 by an external stimulus, such as strain, stress, or temperature.

The beam size of the beam output from the variable beam generator may control the wavelength of a reflected beam by adjusting a grating spacing of the chirped FBG, thereby changing the beam size of the beam by adjusting the time difference between a reflected beam of a long wavelength and a reflected beam of a short wavelength being reflected from the grating and emitted via an input port.

The relationship between the grating spacing of the first chirped FBG 951 or the second chirped FBG 961 and the wavelength of the reflected beam may be defined as Equation 1.

λ_{FBG}=2n_{eff}Λ [Equation 1]

In this case, λ_{FBG} may be the wavelength of a beam reflected by a grating Λ of the first chirped FBG 951 or the second chirped FBG 961, and n_{eff} may be an effective refractive index of optical fiber of the first chirped FBG 951 or the second chirped FBG 961.

In addition, the time difference of the beam reflected from the first chirped FBG 951 or the second chirped FBG 961 may be calculated by a combination of Equations 2 and 3.

$$τ ( ω ) = {β}_{2} L ( ω - {ω}_{0} ) \qquad [ Equation 2 ]$$

$${β}_{2} = 2 π c / ( {ω}_{0}^{2} {v}_{g} Δ {λ}_{chirp} ) \qquad [ Equation 3 ]$$

In this case, v_{g} may be a group velocity of the optical fiber, and L=2L_{g} may be satisfied. In addition, L_{g} may be the grating length. τ(ω) may denote the time for a beam to travel through the optical fiber and may be a parameter related to a beam reflected from the optical fiber and returning as an input. In addition, β₂ may denote the effective velocity at which the actual beam travels through the optical fiber. In addition, ω₀ may denote a central angular frequency of the Bragg grating, and Δλ_{chirp} may denote an FBG bandwidth.

For example, Δλ_{chirp} may be defined as Equation 4.

Δλ_{chirp}=2n_{eff}(Λ_{long}−Λₛₕₒᵣₜ) [Equation 4]

Λ_{long} may indicate that the grating cycle is longer than a reference cycle, and Λₛₕₒᵣₜ may indicate that the grating cycle is shorter than the reference cycle.

FIG. 10 is a diagram illustrating a principle of reducing the size of a PAT beam by a variable beam generator of a wireless transmission signal beam alignment system according to an embodiment.

As shown in FIG. 10, a beam output from the second switch 940 may pass through the first optical circulator 950 and may be incident on the first chirped FBG 951. In this case, the grating cycle of the first chirped FBG 951 may be designed to reflect a short wavelength first. Accordingly, in a wavelength-wise group time delay graph by the first chirped FBG 951, since the short wavelength is reflected first, a group time delay may be small in the short wavelength, and as the wavelength increases, the group time delay may increase.

Accordingly, the beam reflected from the first chirped FBG 951 and incident on the first optical circulator 950 may inversely compensate for the wavelength-wise time delay, thereby decreasing the group time delay and the beam size compared to a beam output from the second switch 940. In addition, the beam with reduced beam size may pass through the first optical circulator 950 and the optical amplifier 980 to amplify the signal intensity and may be output.

FIG. 11 is a diagram illustrating a principle of increasing the size of a PAT beam by a variable beam generator of a wireless transmission signal beam alignment system according to an embodiment.

As shown in FIG. 11, a beam output from the second switch 940 may pass through the second optical circulator 960 and may be incident on the second chirped FBG 961. In this case, the grating cycle of the first chirped FBG 961 may be designed to reflect a long wavelength first. Accordingly, in a wavelength-wise group time delay graph by the second chirped FBG 961, since the long wavelength is reflected first, a group time delay may be small in the long wavelength, and as the wavelength decreases, the group time delay may increase.

Accordingly, the beam reflected from the second chirped FBG 961 and incident on the second optical circulator 960 may compensate by adding the wavelength-wise time delay, thereby increasing the beam size compared to a beam output from the second switch 940. In addition, the beam with increased beam size may pass through the second optical circulator 960 and the optical amplifier 980 to amplify the signal intensity and may be output.

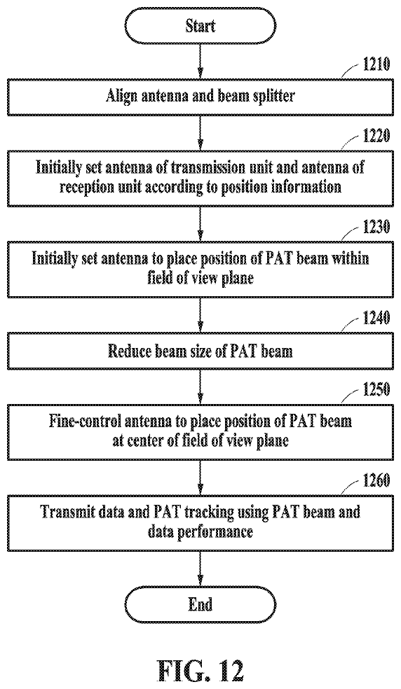

FIG. 12 is a flowchart illustrating a wireless transmission signal beam alignment method according to an embodiment.

In operation 1210, the PAT transceiver 120 of a transmission unit may control the antenna 111 such that a PAT beam is aligned with a wireless transmitter signal beam in parallel using the quad cell 112 and a camera FPA 124. In this case, the PAT transceiver 120 may transmit a PAT beam having an arbitrary beam size to the quad cell 112 and the PAT transceiver 140 of a reception unit via the beam splitter 125. In addition, the PAT transceiver 140 of the reception unit may align the antenna 131 such that a position of the PAT beam having the arbitrary beam size that the camera FPA 144 receives corresponds to a position of the PAT beam having the arbitrary beam size that the beam splitter 145 receives. Specifically, the PAT transceiver 140 may control the antenna 131 such that the position of the PAT beam having the arbitrary beam size that the quad cell 132 receives coincides with the position of the PAT beam having the arbitrary beam size that the camera FRA 144 receives, thereby aligning the PAT beam having the arbitrary beam size with the wireless transmission signal beam in parallel. In addition, when the position of the PAT beam having the arbitrary beam size is at the center of the camera FPA 144, the PAT transceiver 140 may align the PAT beam having the arbitrary beam size with the wireless transmission signal beam in parallel by adjusting the antenna 131 to maximize the intensity of the wireless transmission signal beam that the antenna 131 receives.

In operation 1220, the PAT transceiver 120 may initially set the antenna 111 according to position information of the reception unit, obtained using the GPS, and the PAT transceiver 140 may initially set the antenna 131 according to position information of the transmission unit, obtained using the GPS.

In operation 1230, the PAT transceiver 120 may transmit a PAT beam having a beam size greater than or equal to a reference value to the quad cell 112 and the PAT transceiver 140. When the beam size of the PAT beam used in operation 1210 is greater than or equal to the reference value, the PAT transceiver 120 may transmit the PAT beam to the quad cell 112 and the PAT transceiver 140 without the size modification of the PAT beam. When the beam size of the PAT beam used in operation 1210 is less than the reference value, the PAT transceiver 120 may increase the beam size of the PAT beam to the reference value or more. In addition, the PAT transceiver 120 may transmit the PAT beam having the increased beam size greater than or equal to the reference value to the quad cell 112 and the PAT transceiver 140.

The beam splitter 145 of the PAT transceiver 140 may receive a PAT beam that has a beam size greater than or equal to the reference value and is transmitted from the PAT transceiver 120 via the alignment channel 102 and may transmit the PAT beam to the camera FPA 144. In addition, the PAT transceiver 140 may perform coarse alignment to control the antenna 131 such that the position of the PAT beam that has the beam size greater than or equal to the reference value and is received from the camera FPA 144 is placed within the field of view plane.

In operation 1240, the PAT transceiver 120 may reduce the beam size of the PAT beam used in operation 1230 to less than the reference value.

In operation 1250, the PAT transceiver 120 may transmit the PAT beam having the reduced beam size in operation 1240 to the quad cell 112 and the PAT transceiver 140. In this case, the beam splitter 145 of the PAT transceiver 140 may receive the PAT beam having the reduced beam size to less than the reference value from the PAT transceiver 120 via the alignment channel 102 and may transmit the PAT beam to the camera FPA 144. In addition, the PAT transceiver 140 may perform gradually fine alignment for fine-controlling the antenna 131 such that the position of the PAT beam that the camera FPA 144 receives is placed at the center of the field of view plane.

In operation 1260, the PAT transceiver 140 may determine whether the position of the PAT beam with reduced beam size is placed at the center of the field of view plane by fine-controlling the antenna 131. When the position of the PAT beam with reduced beam size is not placed at the center of the field of view plane, the PAT transceiver 140 may iteratively perform operation 1250 until the position of the PAT beam with reduced beam size is placed at the center of the field of view plane and may control the antenna 131.

When the position of the PAT beam with reduced beam size is placed at the center of the field of view plane, the PAT transceiver 140 may drive the THz transceiver 130 and may send a request to the THz transceiver 110 for data transmission. The THz transceiver 110 that receives the request for data transmission from the PAT transceiver 140 may generate a wireless transmission signal beam including data by modulating a carrier signal. In addition, the antenna 111 may transmit the wireless transmission signal beam generated by the THz transceiver 110 to the reception unit via the data channel 101. In this case, the THz transceiver 130 may reconstruct data from the wireless transmission signal beam that the antenna 131 receives.

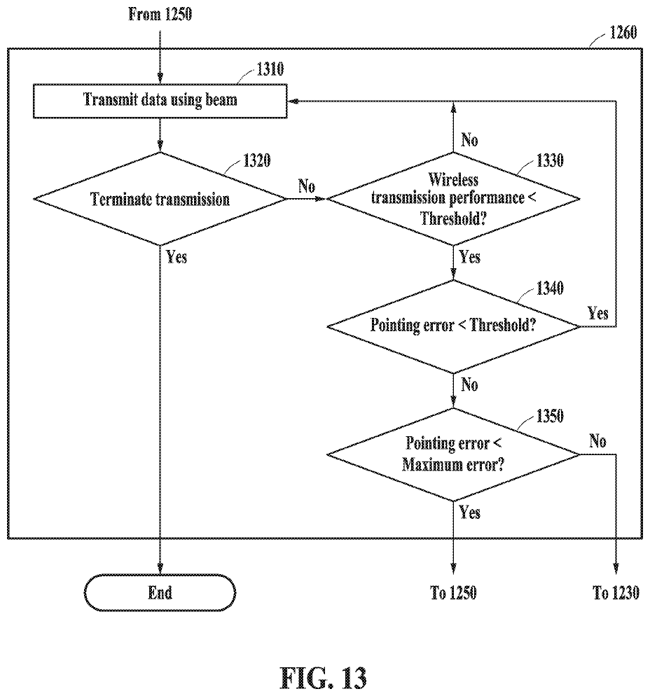

FIG. 13 is a flowchart illustrating a data transmission and PAT tracking process of a wireless transmission signal beam alignment method according to an embodiment. Operations 1310 to 1350 may be included in operation 1260.

In operation 1310, the THz transceiver 110 may generate a wireless transmission signal beam including data by modulating a carrier signal. In addition, the antenna 111 may transmit the wireless transmission signal beam generated by the THz transceiver 110 to the reception unit via the data channel 101. In this case, the THz transceiver 130 may reconstruct data from the wireless transmission signal beam that the antenna 131 receives. In addition, while the data is transmitted from the THz transceiver 110 to the THz transceiver 130, the PAT transceiver 140 may measure wireless transmission performance of the data using the wireless transmission signal beam.

In operation 1320, the PAT transceiver 140 may determine whether the data transmission from the THz transceiver 110 is terminated. When the data transmission from the THz transceiver 110 is terminated, the PAT transceiver 140 may terminate the operation. When the data transmission from the THz transceiver 110 continues, the PAT transceiver 140 may perform operation 1330.

In operation 1330, the PAT transceiver 140 may determine whether the wireless transmission performance is less than or equal to a performance threshold. When the wireless transmission performance is less than or equal to the performance threshold, the PAT transceiver 140 may perform operation 1340. When the wireless transmission performance exceeds the performance threshold, the PAT transceiver 140 may perform operation 1310 until the wireless transmission performance becomes less than or equal to the performance threshold.

In operation 1340, the PAT transceiver 140 may determine whether a pointing error is greater than or equal to a pointing error threshold. When the pointing error is greater than or equal to the pointing error threshold, the PAT transceiver 140 may perform operation 1350. When the pointing error is less than the pointing error threshold, the PAT transceiver 140 may perform operation 1310 until the wireless transceiver performance is less than or equal to the performance threshold and the pointing error is greater than or equal to the pointing error threshold.

In operation 1350, the PAT transceiver 140 may determine whether the pointing error is less than an alignment maximum error. When the pointing error is less than the alignment maximum error, the PAT transceiver 140 may perform operation 1240 to perform gradually fine alignment for realigning the antenna 131 to place the position of the PAT beam with reduced beam size at the center of the field of view plane. When the pointing error is greater than or equal to the alignment maximum error, the PAT transceiver 140 may perform operations 1230 and 1240 to perform coarse alignment for realigning the antenna 131 to place the position of the PAT beam having the beam size greater than or equal to the reference value within the field of view plane. After performing the coarse alignment, the PAT transceiver 140 may perform gradually fine alignment for realigning the antenna 131 such that the position of the PAT beam having the reduced beam size is placed at the center of the field of view plane.

In the present disclosure, limitations of a conventional PAT technology, such as inefficient cost, low precision alignment performance, and long alignment time, may be overcome by performing beam alignment using two or more lasers having different beam sizes.

In other words, the present disclosure may gradually increase or decrease the PAT beam size by adjusting a bandwidth of a broadband light source with a variable filter and adjusting a grating cycle of a chirped FBG.

The present disclosure may minimize beam tracking and alignment time and may precisely align a wireless transmission signal beam with high directivity by aligning it with an optimized beam size according to a transmission environment or a carrier signal rather than a fixed beam size.

Accordingly, the present disclosure may improve long-distance high-speed data transmission performance by rapidly tracking and precisely aligning a high-frequency beam with high directivity.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In some cases, multi-tasking and parallel processing may be advantageous. In addition, it should not be understood that the separation of various device components of the aforementioned embodiments is required for all the embodiments, and it should be understood that the aforementioned program components and apparatuses may be integrated into a single software product or packaged into multiple software products.

The embodiments disclosed in the present specification and the drawings are intended merely to present specific examples in order to aid in understanding of the present disclosure, but are not intended to limit the scope of the present disclosure. It will be apparent to one of one of ordinary skill in the art that various modifications based on the technical spirit of the present disclosure, as well as the disclosed embodiments, may be made.

What is claimed is:

1. A method of aligning a wireless transmission signal beam, the method comprising:
initially setting an antenna of a transmission unit and an antenna of a reception unit according to position information;
transmitting a pointing acquisition tracking (PAT) beam having a beam size greater than or equal to a reference value from a PAT transceiver of the transmission unit;
initially controlling the antenna of the reception unit to place a position of the PAT beam that a PAT transceiver of the reception unit receives, within a field of view plane;
reducing the beam size of the PAT beam to less than the reference value;
transmitting a PAT beam having a reduced beam size from the PAT transceiver of the transmission unit;
receiving the PAT beam having the reduced beam size from the PAT transceiver of the reception unit;
fine-controlling the antenna of the reception unit to place a position of the PAT beam having the reduced beam size at a center of the field of view plane; and
when the position of the PAT beam having the reduced beam size is placed at the center of the field of view plane, transmitting data using a wireless transmission signal beam comprising data.

2. The method of claim 1, further comprising:
before performing the initial setting, transmitting a PAT beam having an arbitrary beam size to the PAT transceiver and a quad cell coupled to the antenna of the reception unit via a beam splitter; and
aligning the antenna of the transmission unit or the antenna of the reception unit such that a position of the PAT beam having the arbitrary beam size that the quad cell coupled to the antenna of the reception unit receives corresponds to a position of the PAT beam having the arbitrary beam size that a beam splitter of the reception unit receives.

3. The method of claim 1, further comprising:
measuring wireless transmission performance of data using the wireless transmission signal beam;
when the wireless transmission performance is less than or equal to a performance threshold, determining whether a pointing error, which is a difference between the position of the PAT beam having the reduced beam size and a center of the field of view plane, is greater than or equal to a pointing error threshold; and
when the pointing error is greater than or equal to the pointing error threshold, realigning the antenna of the transmission unit and the antenna of the reception unit.

4. The method of claim 3, wherein the transmitting of the data comprises transmitting the data using the wireless transmission signal beam until the wireless transmission performance is less than or equal to the performance threshold or the pointing error is less than or equal to the pointing error threshold.

5. The method of claim 3, wherein the realigning comprises:
when the pointing error is greater than or equal to the pointing error threshold and is less than an alignment maximum error, realigning the antenna of the transmission unit and the antenna of the reception unit to place the position of the PAT beam having the reduced beam size at the center of the field of view plane; and
when the pointing error is greater than or equal to the alignment maximum error, after realigning the antenna of the transmission unit and the antenna of the reception unit to place a position of the PAT beam having the beam size greater than or equal to the reference value within the field of view plane, realigning the antenna of the transmission unit and the antenna of the reception unit to place the position of the PAT beam having the reduced beam size at the center of the field of view plane.

6. A system, comprising a transmission unit and a reception unit, for aligning a wireless transmission signal beam, the system comprising:
the transmission unit configured to:
initially set an antenna of the transmission unit according to position information,
generate a pointing acquisition tracking (PAT) beam having a beam size greater than or equal to a reference value and transmit the PAT beam to the reception unit, and
when a position of the PAT beam that the reception unit receives is placed within a field of view plane, reduce a beam size of the PAT beam to less than the reference value and transmit the PAT beam having the reduced beam size to the reception unit; and
the reception unit configured to:
initially set an antenna of the reception unit according to position information,
initially set the antenna of the reception unit to place the position of the PAT beam that the reception unit receives within the field of view plane,
fine-control the antenna of the transmission unit to place the PAT beam having the reduced beam size and received by the reception unit at a center of the field of view plane, and
when the position of the PAT beam having the reduced beam size is placed at the center of the field of view plane, send a request to the transmission unit for transmitting data,
wherein the transmission unit is further configured to transmit the data to the reception unit using a wireless transmission signal beam comprising the data.

7. The system of claim 6, wherein the transmission unit comprises:
a terahertz transceiver of the transmission unit configured to generate a wireless transmission signal beam comprising data by modulating a carrier signal;
an antenna of the transmission unit configured to transmit the wireless transmission signal beam;
a quad cell coupled to the antenna of the transmission unit and configured to determine whether a PAT beam is aligned in a direction in which the antenna of the transmission unit is oriented; and
a PAT transceiver of the transmission unit configured to transmit the PAT beam and control the antenna of the transmission unit,
wherein the reception unit comprises:
an antenna of the reception unit configured to receive the wireless transmission signal beam;
a terahertz transceiver of the reception unit configured to reconstruct data from a wireless transmission signal beam that the antenna of the reception unit receives; and
a PAT transceiver of the reception unit configured to control the antenna of the reception unit.

8. The system of claim 7, wherein the PAT transceiver of the transmission unit is further configured to, before performing the initial setting, transmit a PAT beam having an arbitrary beam size to the quad cell of the reception unit and the PAT transceiver of the reception unit via an alignment channel and the antenna of the transmission unit, and
the PAT transceiver of the reception unit is further configured to align the antenna of the reception unit such that a position of the PAT beam that has the arbitrary beam size and is received by the quad cell of the reception unit corresponds to a position of the PAT beam that has the arbitrary beam size and is received via the alignment channel.

9. The system of claim 7, wherein the PAT transceiver of the reception unit is further configured to:
measure wireless transmission performance of data using the wireless transmission signal beam,
when the wireless transmission performance is less than or equal to a performance threshold, determine whether a pointing error, which is a difference between the position of the PAT beam having the reduced beam size and a center of the field of view plane, is greater than or equal to a pointing error threshold, and
when the pointing error is greater than or equal to the pointing error threshold, realign the antenna of the reception unit.

10. The system of claim 9, wherein the PAT transceiver of the reception unit is further configured to:
when the pointing error is greater than or equal to the pointing error threshold and is less than an alignment maximum error, realign the antenna of the reception unit to place the position of the PAT beam having the reduced beam size at the center of the field of view plane, and
when the pointing error is greater than or equal to the alignment maximum error, after realigning the antenna of the reception unit to place a position of the PAT beam having the beam size greater than or equal to the reference value within the field of view plane, realign the antenna of the reception unit to place the position of the PAT beam having the reduced beam size at the center of the field of view plane.

11. The system of claim 7, wherein the PAT transceiver of the transmission unit comprises:
an antenna controller configured to control the antenna of the transmission unit;
a variable beam generator configured to generate PAT beams having different beam sizes;
a collimator configured to correct the PAT beam to be parallel; and
a beam splitter configured to split the PAT beam and transmit a portion of the PAT beam to a quad cell coupled to the antenna of the transmission unit and the other portion of the PAT beam to the PAT transceiver of the reception unit.

12. The system of claim 11, wherein the variable beam generator comprises:
an amplified spontaneous emission (ASE) light source;
a first chirped fiber Bragg grating (FBG) comprising a grating structure in which a long wavelength is reflected first;
a second chirped FBG comprising a grating structure in which a short wavelength is reflected first;
a first switch configured to transmit a beam output from the ASE light source to one of an optical coupler and a second switch;
the second switch configured to transmit a beam received from the first switch to the first chirped FBG and the second chirped FBG;
the optical coupler configured to transmit light received from one of the first switch, the first chirped FBG, and the second chirped FBG to an optical amplifier; and
the optical amplifier configured to amplify and output received light.

13. The system of claim 12, wherein the variable beam generator is further configured to, when the first switch transmits the beam output from the ASE light source to the optical coupler, output a PAT beam having a beam size corresponding to a beam size of the ASE light source.

14. The system of claim 12, wherein the variable beam generator is further configured to, when the second switch transmits the beam output from the ASE light source to the first chirped FBG, increase a beam size of the beam received by the first chirped FBG to the reference value or above and output the PAT beam having the beam size greater than or equal to the reference value.

15. The system of claim 12, wherein the variable beam generator is further configured to, when the second switch transmits the beam output from the ASE light source to the second chirped FBG, reduce a beam size of the beam received by the second chirped FBG to less than the reference value and output the PAT beam having the reduced beam size.

16. The system of claim 12, wherein the variable beam generator further comprises a variable filter configured to select a bandwidth of the beam output from the ASE light source, and
the variable filter is further configured to, when the second switch transmits the beam output from the ASE light source to the first chirped FBG, select the bandwidth of the beam output from the ASE light source to gradually increase a time difference between a short wavelength and a long wavelength of the beam output from the ASE light source.

17. The system of claim 12, wherein the variable beam generator further comprises a variable filter configured to select a bandwidth of the beam output from the ASE light source, and
the variable filter is further configured to, when the switch transmits the beam output from the ASE light source to the second chirped FBG, select the bandwidth of the beam output from the ASE light source to gradually decrease a time difference between a short wavelength and a long wavelength of the beam output from the ASE light source.

18. The system of claim 7, wherein the PAT transceiver of the reception unit comprises:
an antenna controller configured to control the antenna of the reception unit;
a beam splitter configured to receive, from the PAT transceiver of the reception unit, a PAT beam generated by the PAT transceiver of the reception unit and transmit the PAT beam to a camera focal plane array (FPA); and
the camera FPA configured to identify a position of the received PAT beam.

19. The system of claim 7, wherein the terahertz transceiver of the transmission unit comprises:
a first light source configured to output a carrier beam;
a modulator configured to modulate the carrier beam into a data pattern and output a data signal beam;
a second light source configured to output a local signal beam used for beating;
a nonlinear element configured to generate a wireless transmission signal beam by combining the data signal beam with the local signal beam; and
an amplifier configured to amplify and transmit the wireless transmission signal beam to the antenna of the transmission unit.

20. The system of claim 7, wherein the terahertz transceiver of the reception unit comprises:
a mixer configured to perform frequency down conversion on a wireless transmission signal beam that the antenna of the reception unit receives from the antenna of the transmission unit; and
a signal processor configured to reconstruct data transmitted from the terahertz transceiver of the transmission unit from a beam output from the mixer.
